(19) United States
(12) Patent Application Publication
(10) Pub. No.: US 2005/0288166 A1
(43) Pub. Date: Dec. 29, 2005

(54) Lead-free black ceramic composition for filter and filter formed using the same

(76) Inventors: Jun-Kyu Cha, Suwon-si (KR); Dong-Gun Moon, Suwon-si (KR); Myun-Gi Shim, Suwon-si (KR); Ik-Chul Lim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/165,450

(22) Filed: Jun. 23, 2005

(30) Foreign Application Priority Data
Jun. 24, 2004 (KR) 10-2004-0047620
Jun. 29, 2004 (KR) 10-2004-0049723

(51) Int. Cl. C03C 1/04

(52) U.S. Cl. 501/17; 501/14; 501/21; 501/41

(57) ABSTRACT

Provided are an essentially lead-free black ceramic composition for a filter, a filter formed using the same, and a flat display device including the filter. The lead-free black ceramic composition may include at least one compound selected from the group consisting of B₂O₃, BaO, and ZnO; and at least one black pigment selected from the group consisting of TiO, CuO, NiO, MnO₂, Cr₂O₃ and Fe₂O₃. Alternatively, the lead-free black ceramic composition may include Bi₂O₃; at least one compound selected from the group consisting of B₂O₃, SiO₂, P₂O₅, Na₂O₃, Al₂O₃, BaO, ZnO and TiO₂; and at least one black pigment selected from the group consisting of TiO, CuO, NiO, MnO₂, Cr₂O₃ and Fe₂O₃. The lead-free black ceramic composition for a filter essentially does not contain PbO, which harms human beings and the environment. As a result, the use of the composition is not affected by regulations preventing the use of Pb. In addition, the composition can be calcined at a relatively low temperature and consume a small amount of energy.

### CROSS-REFERENCE TO RELATED PATENT APPLICATIONS

This application claims the benefit of Korean Patent Application No. 10-2004-0049723, filed on Jun. 29, 2004, in the Korean Intellectual Property Office, the disclosure of which is incorporated herein in its entirety by reference.

### BACKGROUND OF THE INVENTION

1. Field of the Invention

The present invention relates to a lead-free black ceramic composition for a filter for a flat planel display, and more particularly, to a lead-free black ceramic composition with improved luminous efficiency and contrast ratio.

2. Description of the Related Art

Plasma display panels (PDP) are flat display devices that can be used as home wall TVs, large-scale display devices for office conferences and public places, or the like due to their advantages of wide viewing angle, full color range, quick response speed, large size, and small thickness. PDPs are categorized into direct current (DC) PDPs and alternating current (AC) PDPs according to the structure of discharge cells and a driving voltage thereof.

PDPs have filters on their entire surfaces to prevent the explosion of panels due to external impact and to shield near-infrared rays, which are generated by inert gas plasma, by shielding a non-effective screen

In a filter of a PDP, a glass substrate is surrounded by black ceramic material with a predetermined width so that a non-effective screen of a PDP panel is shielded, thus improving luminosity of the screen significantly. Therefore, as the black ceramic is darker black, better luminous efficiency can be obtained.

Typically, the black matrix is composed of a PbO-containing black ceramic composition. Since this composition has a glass transition temperature of 500° C. or less, black effects can be effectively obtained using small thermal energy. However, the disadvantage of such a composition is the presence of Pb, which is undesirable for the environmental protection.

A black ceramic composition that does not contain PbO has a glass transition temperature of greater than 550° C. and thus must be calcined at a high temperature.

### SUMMARY OF THE INVENTION

The present invention provides environmentally friendly electric applications manufactured using a PbO-free black ceramic composition.

The present invention also provides a lead-free black ceramic composition set forth below for a filter for flat panel display panels. The lead-free black ceramic composition possesses a low glass transition temperature, thus obtaining effective black effects with minimal thermal energy. Also provided are a filter formed using the lead-free black ceramic composition, a method of forming the filter, and a flat display device using the filter.

According to an aspect of the present invention, there is provided a lead-free black ceramic composition for a filter, the composition including: at least one compound selected from the group consisting of B₂O₃, BaO, and ZnO; and at least one black pigment selected from the group consisting of TiO, CuO, NiO, MnO₂, Cr₂O₃ and Fe₂O₃, wherein the composition is free from lead.

According to another aspect of the present invention, there is provided a lead-free black ceramic composition for a filter, the composition including: Bi₂O₃; at least one compound selected from the group consisting of B₂O₃, SiO₂, P₂O₅, Na₂O₃, Al₂O₃, BaO, ZnO and TiO₂; and at least one black pigment selected from the group consisting of TiO, CuO, NiO, MnO₂, Cr₂O₃ and Fe₂O₃, wherein the composition is free from lead.

According to yet another aspect of the present invention, there is provided a filter formed by printing and heat treating the lead-free black ceramic composition.

According to still another aspect of the present invention, there is provided a method of forming a, the method including: (a) mixing and dissolving at least one compound selected from the group consisting of B₂O₃, BaO and ZnO, wherein the compound is free from lead; (b) cooling the dissolved product and then pulverizing the cooled product to form a glass powder; (c) mixing the glass powder with at least one black pigment selected from the group consisting of TiO, CuO, NiO, MnO₂, Cr₂O₃, and Fe₂O₃; (d) forming a composition by mixing the mixed product with an organic vehicle formed by adding a binder and a plasticizer to a solvent; (e) printing the composition on a glass substrate; and (f) heat treating the printed glass substrate.

According to an aspect of the present invention, there is provided a flat display device including a filter, which is formed using a lead-free black ceramic composition including at least one compound selected from the group consisting of B₂O₃, BaO, and ZnO, wherein the compound is free from Pb; and at least one black pigment selected from the group consisting of TiO, CuO, NiO, MnO₂, Cr₂O₃ and Fe₂O₃.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view of a filter of a plasma display panel according to an embodiment of the present invention;

FIG. 2 is a plan view of the filter shown in FIG. 1; and

FIG. 3 is an exploded perspective view of a plasma display panel including the filter shown in FIG. 1.

### DETAILED DESCRIPTION OF THE INVENTION

The present invention will now be described more fully with reference to the accompanying drawings.

A lead-free black ceramic composition for a filter according to an embodiment of the present invention can include at least one compound selected from the group consisting of B₂O₃, BaO, and ZnO, wherein the compound is free from lead; and at least one black pigment selected from the group consisting of TiO, CuO, NiO, MnO₂, Cr₂O₃ and Fe₂O₃.

B₂O₃ is utilized in forming glass and increases a dielectric constant and a linear expansion coefficient of the glass.

BaO decreases a glass transition temperature and increases a dielectric constant and a linear expansion coefficient of the glass. The amount of BaO can be in the range of between about 33.3 to about 100 parts by weight based on 100 parts by weight of B₂O₃. When the amount of BaO exceeds about 100 parts by weight, the characteristics of the glass composition deteriorate significantly, which is not desirable. When the amount of BaO is less than about 33.3 parts by weight, no effect occurs.

ZnO increases the acid resistance and chemical resistance of the glass. The amount of ZnO is preferably present in the range of between about 16.6 and about 114 parts by weight based on 100 parts by weight of B₂O₃. When the amount of ZnO is less than about 16.6 parts by weight, the acid resistance of the glass decreases. When the amount of ZnO exceeds about 114 parts by weight, fluidity undesirably decreases.

The lead-free black composition contains at least one black pigment selected from the group consisting of TiO, CuO, NiO, MnO₂, Cr₂O₃ and Fe₂O₃. TiO, CuO, NiO, MnO₂, Cr₂O₃ and Fe₂O₃ are metal oxides used to make the composition black. That is, the black pigment contained in the composition makes the entire composition black.

The amount of at least one black pigment can be in the range of between about 0.16 to about 28.5 parts by weight based on 100 parts by weight of B₂O₃. When the amount of the at least one black pigment is less than about 0.16 parts by weight, the composition When the amount of at least one black pigment exceeds about 28.5 parts by weight, characteristics of the glass composition deteriorate by the increase of the pigment component, which is not desirable.

In an embodiment of the invention, the amount of one of TiO, CuO, NiO, MnO₂, Cr₂O₃ and Fe₂O₃ can be in the range of between about 0.16 to about 28.5 parts by weight based on 100 parts by weight of B₂O₃.

The composition can have a glass transition temperature of between about 450 to about 550° C., and preferably, between about 480 to about 530° C. Because of such a low glass transition temperature, the composition can be calcined at a low temperature and thus has low energy consumption. In addition, the composition does not harm the human body and is considered environmentally friendly.

A lead-free black ceramic composition for a filter according to another embodiment of the present invention additionally contains Bi₂O₃. In a preferred embodiment, the composition according to the present embodiment includes Bi₂O₃; at least one compound selected from B₂O₃, SiO₂, P₂O₅, Na₂O₃, Al₂O₃, BaO, ZnO and TiO₂, wherein the compound is free from lead; and at least one black pigment selected from TiO, CuO, NiO, MnO₂, Cr₂O₃ and Fe₂O₃.

Bi₂O₃ is used to obtain a low glass transition temperature.

The amount of the at least the compound selected from B₂O₃, SiO₂, P₂O₅, Na₂O₃, Al₂O₃, BaO, ZnO and TiO₂ is preferably in the range of between about 25 and about 100 parts by weight based on 100 parts by weight of Bi₂O₃.

In detail, the amount of B₂O₃ can be in the range of about 1.25 to about 40 parts by weight, the amount of SiO₂ is in the range of about 1.25 to about 20 parts by weight, the amount of P₂O₅ is in the range of about 1.25 to about 40 parts by weight, the amount of Na₂O₃ is present in the range of about 1.25 to about 40 parts by weight, the amount of Al₂O₃ is present in the range of about 1.25 to about 10 parts by weight, the amount of BaO is present in the range of about 1.25 to about 10 parts by weight, the amount of ZnO is present in the range of about 1.25 to about 20 parts by weight, and the amount of TiO₂ is present in the range of about 0.125 to about 10 parts by weight based on 100 parts by weight of Bi₂O₃.

The addition of B₂O₃ increases the glass transition temperature of the composition by increasing a eutectic point, but when the proper amount of B₂O₃ is added, the thermal expansion coefficient is decreased. In preferred embodiments, the amount of B₂O₃ is present in a range of between about 1.25 to about 40 parts by weight based on 100 parts by weight of Bi₂O₃. When the amount of B₂O₃ is less than about 1.25 parts by weight, the decrease of the thermal expansion coefficient of the composition is small. When the amount of B₂O₃ is larger than about 40 parts by weight, the glass transition temperature increases, which is not desirable.

The addition of SiO₂ increases a mechanical strength and decreases the thermal expansion coefficient of the composition. The amount of SiO₂ can be in the range of about 1.25 to about 20 parts by weight based on 100 parts by weight of Bi₂O₃. When the amount of SiO₂ exceeds about 20 parts by weight based on 100 parts by weight of Bi₂O₃, the glass transition temperature undesirably increases. When the amount of SiO₂ is less than about 1.25 parts by weight, no effect occurs.

The addition of P₂O₅ can decrease the glass transition temperature of the composition. In one embodiment of the invention, the amount of P₂O₅ is present in a range of between about 1.25 to about 40 parts by weight based on 100 parts by weight of Bi₂O₃. When the amount of P₂O₅ exceeds about 40 parts by weight based on 100 parts by weight, the durability of the glass is decreased. When the amount of P₂O₅ exceeds about 1.25 parts by weight based on 100 parts by weight, no effects occur.

The addition of Na₂O₃ increases the mechanical strength of the glass. In certain embodiments, the composition includes Na₂O₃, which is present in a range of between about 1.25 to about 40 parts by weight based on 100 parts by weight of Bi₂O₃. When the amount of Na₂O₃ exceeds about 40 parts by weight, the glass transition temperature is increased. When the amount of Na₂O₃ is less than about 1.25 parts by weight, no effects occur.

The addition of Al₂O₃ decreases the thermal expansion coefficient and increases the acid resistance of the glass. The amount of Al₂O₃ can be present in the range of about 1.25 to about 20 parts by weight, and preferably 1.25 to 10 parts by weight, based on 100 parts by weight of Bi₂O₃. When the amount of Al₂O₃ exceeds about 20 parts by weight, the viscosity of the glass increases substantially. When the amount of Al₂O₃ is less than about 1.25 parts by weight, no effects occur.

The addition of BaO decreases the glass transition temperature of the composition. The amount of BaO can be in the range of between about 1.25 and about 10 parts by weight based on 100 parts by weight of Bi₂O₃. When the amount of BaO exceeds about 10 parts by weight, the durability of the glass is decreased.

The composition can include ZnO in an amount of between about 1.25 to about 20 parts by weight based on 100 parts by weight of Bi₂O₃. When the amount of ZnO is less than about 1.25, the acid resistance of the glass is decreased. When the amount of ZnO exceeds about 20 parts by weight, the fluidity of the composition is decreased.

The addition of TiO₂ decreases the thermal expansion coefficient of the glass. In one embodiment, the amount of TiO₂ is present in the range of about 0.125 to about 10 parts by weight based on 100 parts by weight of Bi₂O₃. When the amount of TiO₂ exceeds about 10 parts by weight, the light transmittance of the glass can be decreased.

The present composition further includes at least one black pigment. The amount of the at least one black pigment can be in the range of about 0.16 to about 28.5 parts by weight based on 100 parts by weight of Bi₂O₃.

In detail, the amount of one of TiO, CuO, NiO, MnO₂, Cr₂O₃ and Fe₂O₃ is between about 0.16 and about 28.5 parts by weight based on 100 parts by weight of Bi₂O₃.

Each of TiO, CuO, NiO, MnO₂, Cr₂O₃ and Fe₂O₃ makes the composition black so that external light can be absorbed. The amount of at least one black pigment can be in the range of between about 0.16 to about 28.5 parts by weight. When the amount of at least one black pigment is less than about 0.16 parts by weight, no black effects occur. When the amount of at least one black pigment exceeds about 28.5 parts by weight, the pigment component adversely affects the characteristics of the entire glass composition.

A filter according to one embodiment is formed by printing and heat treating the lead-free black ceramic composition. The filter can further include at least a film selected from an anti-reflective film (AR film), a near infrared ray shielding film, and an electromagnetic wave shielding film.

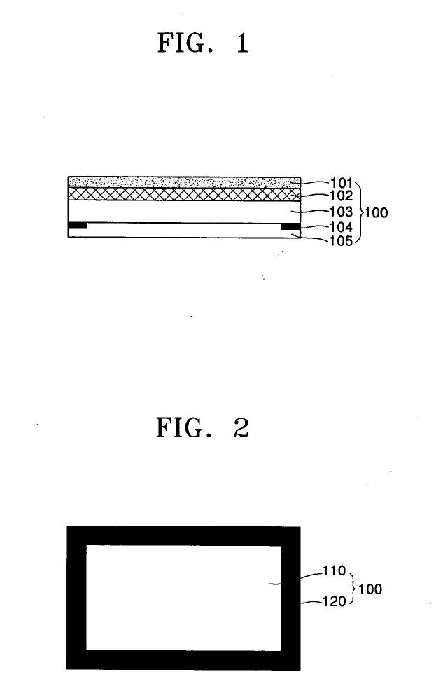

FIG. 1 is a sectional view of a filter 100 of a plasma display panel according to an embodiment of the present invention. Referring to FIG. 1, the filter can include a transparent glass substrate 103; an anti-reflective film 101, a near infrared (NIR) shielding film 102, a 590 nm shielding film (Ne film) and the like formed on a surface of the transparent glass substrate 103; and a black ceramic 104, an electromagnetic wave shielding film 105, and the like formed on another surface of the transparent glass substrate 103. The films composing the filter 100 can be attached to a conductive filter holder, or integrated with a front panel so that they are fixed on a front surface or rear surface of a front substrate.

The black ceramic 104 can increase the contrast ratio of an image by making a non-effective screen black and thus increase luminous efficiency. The black ceramic 104 can be printed to a thickness of about 2 to about 4 cm along the edge of the panel. The electromagnetic wave shielding layer 105 can be a metal mesh film, a conductive material, a metal-containing black additive film, or a Cu film with an oxidized surface. One use of the near infrared ray shielding film 102 is to prevent a malfunction which may occur when a user operates a remote controller. One use of the Ne film is to compensate the color mood of orange and can be formed by dispersing a pigment in a polymer binder and a solvent and coating the dispersed product.

As illustrated in FIG. 1, the anti-reflective film, the near infrared ray shielding film, and the like can be formed on a side of the transparent substrate away from a panel; and the black ceramic composition may be printed on the side of the transparent substrate facing the panel. However, the locations of these films are not limited thereto.

FIG. 2 is a plan view of the filter 100 shown in FIG. 1. The filter 100 printed with the composition according to an embodiment of the present invention includes a central portion 110 facing the glass of a front case, and a surrounding portion 120 surrounding the central portion 110. An anti-reflective film for preventing the external light reflection, a near infrared ray shielding film, a Ne film for shielding visible light of 590 nm, an electromagnet shielding layer for shielding an electromagnetic wave, and the like can be formed in the central portion 110.

A method of forming a filter according to an embodiment of the present invention includes: (a) mixing and dissolving at least one compound selected from the group consisting of B₂O₃, BaO and ZnO, wherein the compound is free from lead; (b) cooling the dissolved product and then pulverizing the cooled product to form a glass powder; (c) mixing the glass powder with at least one black pigment selected from the group consisting of TiO, CuO, NiO, MnO₂, Cr₂O₃, and Fe₂O₃; (d) forming a composition by mixing the mixed product with an organic vehicle formed by adding a binder and a plasticizer to a solvent; (e) printing the composition on a glass substrate; and (f) heat treating the printed glass substrate.

In operation (a), about 33.3 to about 100 parts by weight of BaO and about 16.6 to about 114 parts by weight of ZnO based on 100 parts by weight of B₂O₃ are mixed and dissolved at a temperature of between about 1,000 and about 1,100° C.

In operation (c), the amount of one of TiO, CuO, NiO, MnO₂, Cr₂O₃, and Fe₂O₃ can be in the range of about 16 to about 28.5 parts by weight.

In operation (d), the glass powder and the organic vehicle can be mixed in a ratio of 7:3, thus forming a paste composition. The organic vehicle can be composed of a solvent, a binder, and a plasticizer. The solvent can be formed by mixing butylcarbitol acetate and butylcarbitol, the binder can be, for example, ethyl cellulose, and the plasticizer can be dibutylphthalate, or the like. The organic vehicle can be formed by mixing the solvent, the binder, and the plasticizer at a temperature of between about 70 to about 90° C.

In operation (e), the composition can be screen-printed to a thickness of about 5 to about 30 μm on the glass substrate.

In operation (f), the printed glass substrate can be heat treated at a temperature of between about 500 to about 550° C. to prevent the transformation of the glass substrate. When the heat treating temperature is less than about 500° C., the black effects of the composition are small, and when the heat treating temperature is greater than about 550° C., it is difficult to maintain the size of the film, which is not desirable.

A method of forming a filter according to another embodiment of the present invention includes: (a) mixing and dissolving about 100 parts by weight of Bi₂O₃ and about 25 to about 100 parts by weight of at least one compound selected from the group consisting of B₂O₃, SiO₂, P₂O₅, Na₂O₃, Al₂O₃, BaO, ZnO and TiO₂; (b) coolimg the dissolved product and then pulverizing the cooled product to form a glass powder ; (c) mixing the glass powder with about 0.16 to about 28.5 parts by weight of a black pigment selected from TiO, CuO, NiO, MnO₂, Cr₂O₃, and Fe₂O₃; (d) forming a composition by mixing the glass powder with an organic vehicle formed by adding a binder and a plasticizer to a solvent; (e) printing the composition on a glass substrate; and (f) the heat treating the printed glass substrate.

In operation (a), at least about 100 parts by weight of Bi₂O₃, about 1.25 to about 40 parts by weight of B₂O₃, about 1.25 to about 20 parts by weight of SiO₂, about 1.25 to about 40 parts by weight of P₂O₅, about 1.25 to about 40 parts by weight of Na₂O₃, about 1.25 to about 10 parts by weight of Al₂O₃, about 1.25 to about 10 parts by weight of BaO, about 1.25 to about 20 parts by weight of ZnO, or about 0.125 to about 10 parts by weight of TiO₂ are mixed at a temperature of about 1000 to about 1100° C.

In operation (b), the dissolved product is cooled and then pulverized, thus forming the glass powder.

In operation (c), the glass powder is mixed with at least about 0.16 to about 28.5 parts by weight of TiO, about 0.16 to about 28.5 parts by weight of CuO, about 0.16 to about 28.5 parts by weight of NiO, about 0.16 to about 28.5 parts by weight of MnO₂, about 0.16 to about 28.5 parts by weight of Cr₂O₃, or about 0.16 to about 28.5 parts by weight of Fe₂O₃ based on 100 parts by weight of Bi₂O₃.

Operations (e) and (f) are as described in the previous embodiment.

A flat display device according to an embodiment of the present invention includes a filter formed using a lead-free black ceramic composition, which includes at least one compound selected from B₂O₃, BaO, and ZnO, wherein the compound is free from lead; and at least one black pigment selected from TiO, CuO, NiO, MnO₂, Cr₂O₃ and Fe₂O₃.

The flat display device can include a liquid crystal display (LCD), a field emission device (FED), a plasma display panel (PDP)(enter direct or alternative current), or the like. For convenience, a PDP will be described in greater detail below as an embodiment. However, it will be appreciated that the description presented herein with regard to the PDP is not intended to be interpreted in any limited or restrictive manner, simply because it is being utilized in conjunction with a detailed description of certain specific embodiments of the invention. An LCD, a FED, or the like can be substituted for the PDP described below.

The PDP includes: a transparent front substrate; a rear substrate disposed parallel to the front substrate; a filter formed by printing the lead-free black ceramic composition on a transparent substrate fixed on the front substrate; partition walls disposed between the front substrate and the rear substrate which partition emission cells; address electrodes which extend along the emission cells disposed in a row and are covered by a rear dielectric layer; a fluorescent layer disposed in the emission cells; a pair of sustain electrodes which extend perpendicular to the address electrodes and are covered by a front dielectric layer; and a discharge gas in the emission cells.

The PDP can further include at least a film selected from an anti-reflective film, a near infrared ray shielding film, and an electromagnetic wave shielding film.

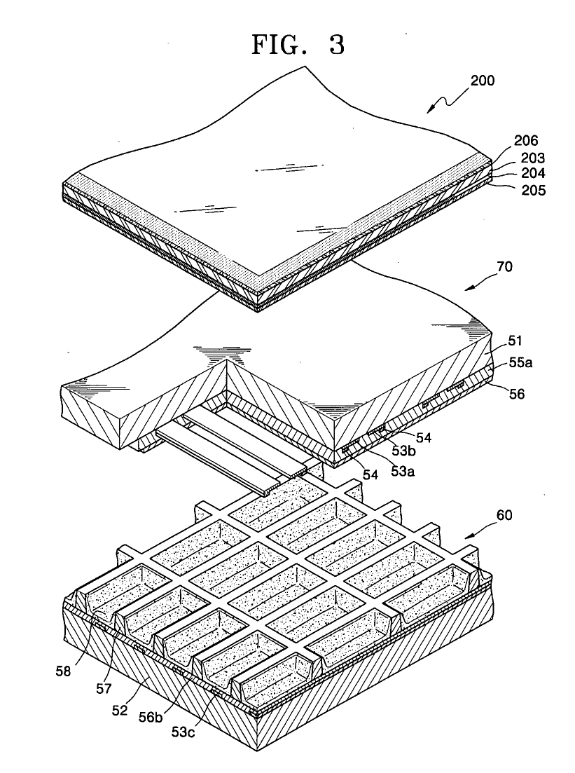

FIG. 3 illustrates a filter 200, a front panel 70, and a rear panel 60 of the PDP. In the filter 200, the black ceramic composition is printed to a thickness of 2 to 4 cm on a transparent substrate 203; an anti-reflective film or near infrared ray shielding layer 206, and the like are disposed on a side of the transparent substrate 203; and a metal mesh layer 205 and the like are disposed on another side of the transparent substrate 203. The front panel 70 includes a front substrate 51, a pair of sustain electrodes including Y and X electrodes formed on a rear surface of the front substrate 51, a front dielectric layer 55a covering the sustain electrodes, and a protecting layer 56 covering the front dielectric layer 55a. The Y and X electrodes, respectively, include transparent electrodes 53a and 53b composed of, for example, ITO and bus electrodes 54 composed of a conductive metal. The rear panel 60 includes a rear substrate 52, address electrodes 53c disposed perpendicular to the sustain electrodes on the entire surface of the rear substrate 52, a rear dielectric layer 56b covering the address electrodes 53c, a partition wall 57 which partitions emission cells and is formed on the rear dielectric layer 56b, and a fluorescent layer 58 disposed in the emission cell.

In the PDP with the above-described structure, the filter 200 is manufactured separately from a filter holder and coupled to a front case so that a predetermined space is formed. However, the structure of the PDP is not limited thereto. For example, the filter 200 can be attached to the front substrate 51.

The present invention will now be described in more detail with reference to the following Examples. These examples are provided for illustrative purposes only, and are not intended to limit the scope of the present invention.

### EXAMPLES

### Example 1

### Preparation of Lead-Free Ceramic Paste Composition with Cr₂O₃ and CuO

100 parts by weight of B₂O₃, 85.7 parts by weight of BaO, and 100 parts by weight of ZnO were measured and dried using a dry ball mill for longer than 24 hours, thus producing a powder mixture. The power mixture was sufficiently dissolved in an alumina pot at a temperature of 1000 to 1100° C. for about 2 hours and then cooled, thus forming glass. The glass was pulverized using the ball mill so that glass powder with an average diameter of 1.5 μm was obtained. Then, a black pigment including 0.66 parts by weight of Cr₂O₃ and 0.66 parts by weight of CuO was added to the glass powder.

Ethyl cellulose was added to a solution mixture of BUTYL CARBITOL ACETATE™ (Dow Chemicals, Midland, Mich.) and BUTYL CARBITOL™ (Dow Chemicals, Midland, Mich.), in a weight ratio of 10:90. Then, the resulting product was mixed with dibutylpthalate and stirred at 90° C. to form an organic vehicle. The glass powder was mixed with the organic vehicle in a ratio of 7:3, thus forming a lead-free black ceramic paste composition.

The lead-free black ceramic paste composition was printed to a thickness of 10 μm on an ultra wave-cleaned soda-lime glass substrate using screen printing equipment which had a 200 mesh stainless steel mask frame. The result was calcined at 550° C. for 10 minutes and then a degree of black was measured. L, a, and b were 23.8, −0.12, and 0.03, respectively. Typically, as L decreases and a and b are almost 0, the degree of black increases.

### Example 2

### Preparation of Lead-Free Black Ceramic Paste Comprising B₂O₃, BaO, ZnO, and CuO

100 parts by weight of B₂O₃, 85.7 parts by weight of BaO, and 85.7 parts by weight of ZnO were measured, and then glass powder was manufactured in the same manner as in Example 1. Then, 1.53 parts by weight of CuO as a black pigment was added to the glass powder, and a lead free black ceramic paste composition was formed in the same manner as in Example 1. The composition was doped by screen printing and calcined such that the thickness was 10 μm. The result was calcined at 550° C. for 10 minutes and a degree of black was measured. L, a and b were 23.25, −0.05 and 0.02, respectively.

### Example 3

### Preparation of Lead Free Black Ceramic Paste Comprising Bi₂O₃, SiO₂, and P₂O₅

100 parts by weight of Bi₂O₃, 20 parts by weight of B₂O₃, 8 parts by weight of SiO₂, 4 parts by weight of P₂O₅ were measured and dried using a dry ball mill for longer than 24 hours, thus producing a powder mixture. The power mixture was sufficiently dissolved in an alumina pot at a temperature of about 1000 to about 1100° C. for about 2 hours and then cooled, thus forming glass. The glass was sufficiently pulverized using the ball mill so that glass powder with an average diameter of 1.5 μm was obtained. Then, a black pigment including 0.66 parts by weight of Cr₂O₃ and 0.66 parts by weight of CuO was added to the glass powder.

Ethyl cellulose was added to a solution mixture of BUTYL CARBITOL ACETATE™ (Dow Chemicals, Midland, Mich.) and BUTYL CARBITOL™ (Dow Chemicals, Midland, Mich.) in a weight ratio of 10:90. Then, the resulting product was mixed with dibutylpthalate and stirred at 90° C. to form an organic vehicle. The glass powder was mixed with the organic vehicle in a ratio of 7:3, thus forming a lead-free black ceramic paste composition.

The lead-free black ceramic paste composition was printed to a thickness of 10 μm on a ultra wave-cleaned soda-lime glass substrate using screen printing equipment, which had a 200 mesh stainless steel mask frame. The result was calcined at 550° C. for 10 minutes and then a degree of black was measured. L, a, and b were 23.3, −0.05, and 0.07, respectively. Typically, as L is decreased and a and b are almost 0, the degree of black increases.

### Example 4

### Preparation of Lead-Free Black Ceramic Composition Comprising Bi₂O₃, B₂O₃ and SiO₂

100 parts by weight of Bi₂O₃, 30.7 parts by weight of B₂O₃, 15.3 parts by weight of SiO₂, 6.15 parts by weight of P₂O₅ were measured, and then a glass power was manufactured in the same manner as in Example 1. Then, 1.53 parts by weight of CuO as a black pigment was added to the glass powder, and a lead free black ceramic paste composition was formed in the same manner as in Example 1. The composition was doped by screen printing and calcined such that the thickness of the composition was 10 μm. The result was calcined at 550° C. for 10 minutes and a degree of black was measured. L, a and b were 23.75, −0.10 and 0.12, respectively.

### Comparative Example 1

### Comparative Example of Example 1 using Lead

Comparative Example 1 was performed in the same manner as Example 1 except that a conventional lead black ceramic (Shinceramic Co., Ltd.: the glass powder contains PbO, SiO₂, Na₂O₃, and the like, and the black pigment contains Cr₂O₃ and CuO) was used. L, a, and b were 23.41, −0.08, and 0.12, respectively.

### Comparative Example 2

### Comparative Example of Example 2 using Conventional Lead-Free Black Ceramic

Comparative Example 2 was performed in the same manner as in Example 1 except that a conventional lead-free black ceramic (Shinceramic Co., Ltd.: the glass powder contains SiO₂, Na₂O₃, and the like, and the black pigment contains Cr₂O₃ and CuO) was used. L, a, and b were 27.22, −0.05, and 0.15, respectively

### Comparative Example 3

### Comparative Example of Example 3 using Conventional Lead-Free Black Ceramic

The lead-free black ceramic (Shinceramic Co., Ltd.: the glass powder contains SiO₂, Na₂O₃, and the like, and the black pigment contains Cr₂O₃ and CuO) used in Comparative Example 2 was screen printed and then calcined such that the thickness was 10 μm. The result was calcined at 600° C. for 10 minutes and a degree of black was measured. L, a, and b were 23.64, −0.10, and 0.17, respectively.

TABLE 1
Color coordinates according to black paste type

| | L | a | b |
|---|---|---|---|
| Example 1 | 23.8 | −0.12 | 0.03 |
| Example 2 | 23.25 | −0.05 | 0.02 |
| Example 3 | 23.3 | −0.05 | 0.07 |
| Example 4 | 23.75 | −0.10 | 0.12 |
| Comparative Example 1 | 23.41 | −0.08 | 0.12 |
| Comparative Example 2 | 27.22 | −0.05 | 0.15 |
| Comparative Example 3 | 23.64 | −0.10 | 0.17 |

In Comparative Example 1, L of the color coordinate was sufficiently small that the degree of black of the black ceramic was large and thus excellent luminous efficiency of the PDP could be obtained. However, the use of the composition will not be permissible when environmental regulations are strengthened due to the existence of Pb therein.

In Comparative Example 2, the composition does not contain Pb and thus will not be restricted by environmental regulations. However, the composition was calcined at 550° C., and thus L was relatively large, which indicates the color is much grayer than the Examples according to embodiments of the present invention.

In Comparative Example 3, the composition does not contain Pb and L was desirable. However, the calcination temperature was relatively high and large energy consumption was required, thus resulting in an economic loss.

In Examples 1 through 4, the glass compositions did not contain Pb. In addition, the glass compositions had low glass transition temperatures and thus small thermal energy was required to obtain effective luminous efficiency.

According to the present invention, a lead-free black ceramic composition that does not contain PbO, a compound which harms human beings and the environment, can be manufactured. The present composition is harmless to human beings and environmentally friendly and thus is not affected by regulations restricting the use of Pb. In addition, the composition can be calcined at a relatively low temperature and consumes small amount of thermal energy.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A lead-free black ceramic composition for a flat panel display device filter, the composition comprising:
at least one compound selected from the group consisting of B₂O₃, BaO, and ZnO;
at least one black pigment selected from the group consisting of TiO, CuO, NiO, MnO₂, Cr₂O₃ and Fe₂O₃; and
wherein said composition is free from lead.

2. The lead-free black ceramic composition of claim 1, wherein the amount of BaO is in the range of about 33.3 to about 100 parts by weight based on 100 parts by weight of B₂O₃.

3. The lead-free black ceramic composition of claim 1, wherein the amount of ZnO is in the range of about 16.6 to about 114 parts by weight based on 100 parts by weight of B₂O₃.

4. The lead-free black ceramic composition of claim 1, wherein the amount of the at least one black pigment selected from the group consisting of TiO, CuO, NiO, MnO₂, Cr₂O₃ and Fe₂O₃ is in the range of about 0.16 to about 28.5 parts by weight based on 100 parts by weight of B₂O₃.

5. The lead-free black ceramic composition of claim 4, wherein the amount of one of TiO, CuO, NiO, MnO₂, Cr₂O₃ and Fe₂O₃ is in the range of about 0.16 to about 28.5 parts by weight based on 100 parts by weight of B₂O₃.

6. The lead-free black ceramic composition of claim 1 having a glass transition temperature of about 450 to about 550° C.

7. The lead-free black ceramic composition of claim 6, wherein the glass transition temperature is in the range of about 480 to about 530° C.

8. A lead-free black ceramic composition for a filter, the composition comprising:
Bi₂O₃;
at least one compound selected from the group consisting of B₂O₃, SiO₂, P₂O₅, Na₂O₃, Al₂O₃, BaO, ZnO and TiO₂;
at least one black pigment selected from the group consisting of TiO, CuO, NiO, MnO₂, Cr₂O₃ and Fe₂O₃; and
wherein the composition is free from lead.

9. The lead-free black ceramic composition of claim 8, wherein the amount of the at least one compound selected from the group consisting of B₂O₃, SiO₂, P₂O₅, Na₂O₃, Al₂O₃, BaO, ZnO and TiO₂ is in the range of about 25 to about 100 parts by weight base on 100 parts by weight of Bi₂O₃.

10. The lead-free black ceramic composition of claim 9, wherein the amount of B₂O₃ is in the range of about 1.25 to about 40 parts by weight, the amount of SiO₂ is in the range of about 1.25 to about 20 parts by weight, the amount of P₂O₅ is in the range of about 1.25 to about 40 parts by weight, the amount of Na₂O₃ is in the range of about 1.25 to about 40 parts by weight, the amount of Al₂O₃ is in the range of about 1.25 to about 10 parts by weight, the amount of BaO is in the range of about 1.25 to about 10 parts by weight, the amount of ZnO is in the range of about 1.25 to about 20 parts by weight, and the amount of TiO₂ is in the range of about 0.125 to about 10 parts by weight based on 100 parts by weight of Bi₂O₃.

11. The lead-free black ceramic composition of claim 8, wherein the amount of the at least one black pigment is in the range of about 0.16 to about 28.5 parts by weight based on 100 parts by weight of Bi₂O₃.

12. The lead-free black ceramic composition of claim 11, wherein the amount of each of TiO, CuO, NiO, MnO₂, Cr₂O₃ and Fe₂O₃ is in the range of about 0.16 to about 28.5 based on 100 parts by weight of Bi₂O₃.

13. A filter formed by printing and heat treating the lead-free black ceramic composition according to claim 1.

14. The filter of claim 13, further comprising at least a film selected from the group consisting of an anti-reflective (AR) film, a near infrared ray shielding film, and an electromagnetic wave shielding film.

15. The filter of claim 13, wherein said lead-free black ceramic composition is printed to a thickness of between about 2 to about 4 cm.

16. A method of forming a filter, the method comprising:
(a) mixing and dissolving at least one compound selected from the group consisting of B₂O₃, BaO and ZnO;
(b) cooling the dissolved product in a short time and then pulverizing the cooled product to form a glass powder;
(c) mixing the glass powder with at least one black pigment selected from the group consisting of TiO, CuO, NiO, MnO₂, Cr₂O₃, and Fe₂O₃;
(d) forming a composition by mixing the mixed product with an organic vehicle formed by adding a binder and a plasticizer to a solvent, wherein said composition is free from lead;
(e) printing the composition on a glass substrate; and
(f) heat treating the printed glass substrate.

17. The method of claim 16, wherein in operation (a), the amount of BaO is in the range of about 33.3 to about 100 parts by weight and the amount of ZnO is in the range of about 16.6 to about 114 parts by weight based on 100 parts by weight of B₂O₃.

18. The method of claim 16, wherein, in operation (c), the amount of one of TiO, CuO, NiO, MnO₂, Cr₂O₃, and Fe₂O₃ is in the range of about 0.16 to about 28.5 parts by weight based on 100 parts by weight of B₂O₃.

19. The method of claim 16, wherein, in operation (d), the glass powder is mixed with the organic vehicle in a ratio of 7:3.

20. The method of claim 16, wherein, in operation (e), the composition is printed to a thickness of about 5 to about 30 μm on a glass substrate.

21. The method of claim 16, wherein, in operation (f), the heat treatment is performed at a temperature of about 500 to about 550° C.

22. A flat display device comprising the filter of claim 13.

23. The flat display device of claim 21, being one of a plasma display panel, a liquid crystal display, and a field emission device.

24. The flat display panel of claim 22, wherein the plasma display panel further comprises at least a film selected from the group consisting of an anti-reflective film, a near infrared ray shielding film, and an electromagnetic wave shielding film.
